(19) United States
(12) Patent Application Publication
(10) Pub. No.: US 2024/0403754 A1
(43) Pub. Date: Dec. 5, 2024

(54) MANAGEMENT SYSTEM, MANAGEMENT DEVICE, TERMINAL DEVICE, AND MANAGEMENT PROGRAM

(71) Applicant: LIXIL Corporation, Tokyo (JP)

(72) Inventors: Shoji OGAWA, Tokyo (JP); Hiroki SHIGETOMO, Tokyo (JP); Toshiki HASHIDA, Tokyo (JP); Yusuke NAMAI, Tokyo (JP); Masanori MAKIHARA, Tokyo (JP)

(73) Assignee: LIXIL Corporation, Tokyo (JP)

(21) Appl. No.: 18/700,245

(22) PCT Filed: Sep. 21, 2022
(86) PCT No.: PCT/JP2022/035280

§ 371 Date: Apr. 10, 2024

(30) Foreign Application Priority Data
Oct. 13, 2021 (JP) 2021-168005

(51) Int. Cl. G06Q 10/0631

(52) U.S. Cl. CPC G06Q 10/063114

(57) ABSTRACT

A management system includes: a cleaning person terminal used by a cleaning person for a toilet bowl device; and a management device managing cleaning of a plurality of toilet bowl devices. The management device includes: a controller configured to: acquire information acquired by sensors installed in the plurality of toilet bowl devices or at the installation locations thereof; determine toilet bowl devices to be cleaned based on the information acquired by the controller; determine the cleaning order of the plurality of toilet bowl devices determined to be cleaned by the controller; and notify the cleaning person terminal of the cleaning order determined by the controller. The cleaning person terminal includes a display that presents the cleaning order of the toilet bowl devices notified by the management device to the cleaning person.

### CROSS-REFERENCE TO RELATED APPLICATIONS

This application is a national stage application under 35 USC 371 of International Application No. PCT/JP2022/035280, filed Sep. 21, 2022, which claims the priority of Japanese Application No. 2021-168005, filed Oct. 13, 2021. The entire contents of each priority application is incorporated herein by reference.

### FIELD OF THE DISCLOSURE

The present disclosure relates to a management system, a management device, a terminal device, and a management program for managing the cleaning of toilet bowl devices.

### BACKGROUND OF THE DISCLOSURE

Toilets are essential facilities both in residences where people live and in facilities used by people. Since these facilities are prone to stains and odors, management for maintaining the cleanliness of toilets is an important key to making homes and facilities comfortable spaces. In particular, the maintenance of toilets installed in commercial facilities, entertainment facilities, multi-purpose facilities, passenger station facilities, and the like that are used by a large number of people need to be properly managed from the viewpoint of public health.

The cleaning company entrusted by the facility manager to clean the toilets patrols and cleans all the toilets several times a day according to a set manual. In the case of large facilities, where the number of toilets can be in the hundreds, dozens of cleaning persons take the time and effort to clean all the toilets.
Patent Literature 1: JP 2003-242230

### SUMMARY OF THE DISCLOSURE

As described, the cleaning of toilets installed in facilities currently relies on human tactics by a large number of cleaning persons, which requires a great deal of labor and expense. There is a need to improve the efficiency of toilet cleaning.

The present disclosure addresses the issue described above, and a purpose thereof is to provide a technology for properly managing the cleaning of toilet bowl devices.

In order to solve the above problem, a management system according to one aspect of the present disclosure includes: a terminal device that is used by a cleaning person for a toilet bowl device; and a management device that manages cleaning of a plurality of toilet bowl devices. The management device includes: a detection information acquisition unit that acquires information acquired by sensors installed in the plurality of toilet bowl devices or at the installation locations of the plurality of toilet bowl devices; a cleaning necessity determination unit that determines toilet bowl devices to be cleaned based on the information acquired by the detection information acquisition unit; a cleaning order determination unit that determines the cleaning order of the plurality of toilet bowl devices that are determined to be cleaned by the cleaning necessity determination unit; and a notification unit that notifies the terminal device of the cleaning order determined by the cleaning order determination unit. The terminal device includes a presentation unit that presents the cleaning order of the toilet bowl devices as notified by the management device to the cleaning person.

Another aspect of the present disclosure relates to a management device. This device includes: a detection information acquisition unit that acquires information acquired by sensors installed in the plurality of toilet bowl devices or at the installation locations of the plurality of toilet bowl devices; a cleaning necessity determination unit that determines toilet bowl devices to be cleaned based on the information acquired by the detection information acquisition unit; a cleaning order determination unit that determines the cleaning order of the plurality of toilet bowl devices that are determined to be cleaned by the cleaning necessity determination unit; and a notification unit that notifies the terminal device used by a cleaning person for the toilet bowl devices of the cleaning order determined by the cleaning order determination unit.

Still another aspect of the present disclosure relates to a terminal device. This device includes: a presentation unit that determines toilet bowl devices to be cleaned based on information acquired by sensors installed in a plurality of toilet bowl devices or at the installation locations of the plurality of toilet bowl devices and presents to a cleaning person the cleaning order of the toilet bowl devices determined to be cleaned as notified by a management device that determines the cleaning order of the toilet bowl devices determined to be cleaned.

Optional combinations of the aforementioned constituting elements and implementations of the present disclosure in the form of methods, apparatuses, systems, recording mediums, and computer programs may also be practiced as additional aspects of the present disclosure.

### BRIEF DESCRIPTION OF THE FIGURES

FIG. 1 is a diagram showing the configuration of a management system according to an embodiment.

FIG. 2 is a sequence diagram showing the procedure of a management method according to the embodiment.

FIG. 3 is a diagram showing an example of a display screen displayed by a cleaning person terminal.

FIG. 4 is a diagram showing an example of a display screen displayed by a cleaning person terminal.

FIG. 5 is a diagram showing an example of a display screen displayed by a cleaning person terminal.

FIG. 6 is a diagram showing the configuration of a management device according to the embodiment.

FIG. 7 is a diagram showing the configuration of a cleaning person device according to the embodiment.

### DETAILED DESCRIPTION OF THE DISCLOSURE

As an embodiment of the present disclosure, a technique for managing the cleaning of a plurality of toilet bowl devices will be described. In a management system according to the present embodiment, instead of regularly patrolling all of the plurality of toilet bowl devices, a cleaning person cleans only those toilet bowl devices that are determined to be cleaned by a management device. This eliminates unnecessary cleaning of unused toilet bowl devices conducted repeatedly every day, and allows for appropriate cleaning of toilet bowl devices according to the frequency of use, etc., thereby greatly improving the efficiency of cleaning a plurality of toilet bowl devices.

The management device determines which toilet bowl devices to be cleaned, determines the cleaning order among a plurality of toilet bowl devices determined to be cleaned, and notifies a terminal device of the cleaning person. The management device determines the order of cleaning the toilet bowl devices while taking into account not only the urgency of the cleaning but also the efficiency of the movement of the cleaning person. This further improves the efficiency of cleaning a plurality of toilet bowl devices. The cleaning person can proceed with the cleaning of toilet bowl devices efficiently simply by cleaning the toilet bowl devices in the order as notified by the management device to the terminal device.

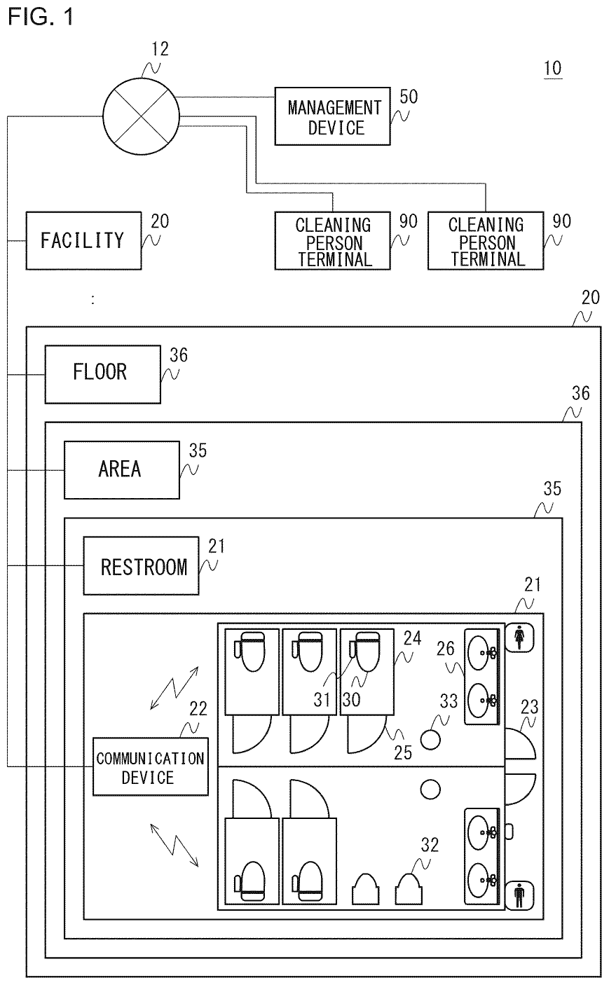

FIG. 1 shows the configuration of a management system according to the embodiment. A management system 10 includes a management device 50 for managing the cleaning of a plurality of toilet bowl devices 30 installed in a restroom 21 of a facility 20, a communication device 22 that transmits detection information detected by a sensor 33 installed in the restroom 21 to the management device 50, a cleaning person terminal 90 of a cleaning person in charge of cleaning the toilet bowl devices 30, and Internet 12, which is an example of a communication means for communication among these devices.

The facility 20 is layered and managed in a plurality of layers. The facility 20 has one or more floors 36, and a floor 36 has one or more areas 35. Each area 35 has one or more restrooms 21. A restroom 21 has a sensor 33, a door 23 of the restroom 21, a sink 26, one or more private stalls 24, a door 25 of each of the private stalls 24, a toilet bowl device 30 installed in each of the private stalls 24, and a controller 31 for a user of a toilet bowl device 30 to input an operation instruction to the toilet bowl device 30, as well as urinals 32 installed in a restroom 21 for men. The toilet bowel devices 30 may be Japanese-style toilet bowl devices or Western-style toilet bowl devices. The toilet bowel devices 30 as well as the urinals 32 are hereinafter collectively referred to as “toilet bowl devices 30.”

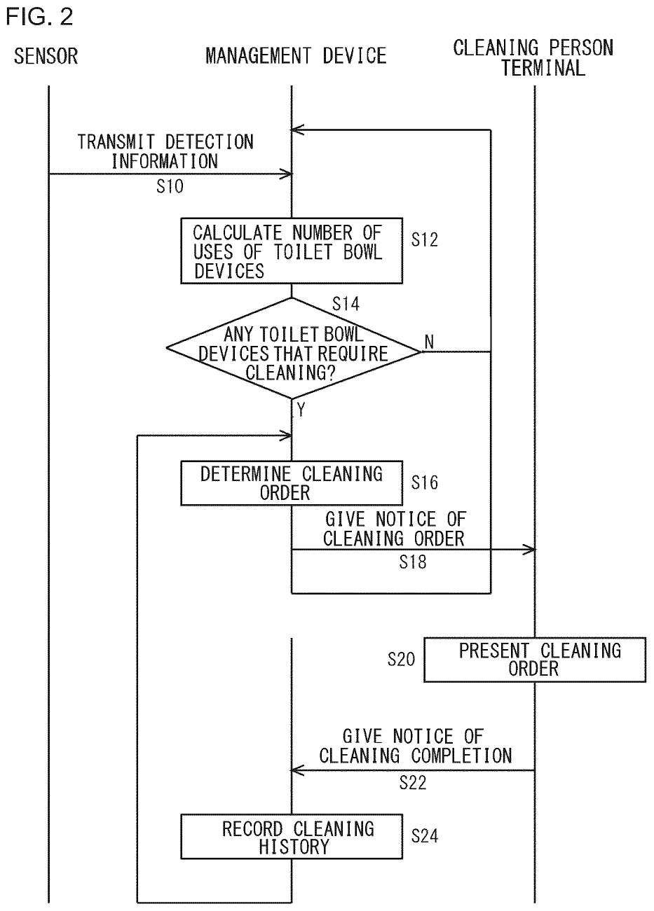

FIG. 2 is a sequence diagram showing the procedure of a management method according to the embodiment. Detection information detected by the sensor 33 is transmitted from the communication device 22 to the management device 50 (S10). The sensor 33 may be, for example, an open/close sensor of the door 25 of a private stall 24, a sensor detecting the locking and unlocking of a key installed in the door 25, a pyroelectric sensor, a motion sensor, a temperature sensor, a seat sensor of a toilet bowl device 30, a drain sensor, a clog sensor, an odor sensor, a stain sensor, a sound sensor, etc.

The management device 50 calculates the number of uses of the toilet bowl device 30 based on the detection information (S12). For example, the management device 50 calculates the number of uses of the toilet bowl device 30 based on the number of openings and closings detected by the open/close sensor of the door 25 of the private stall 24, the number of locking and unlocking detected by the sensor installed on the door 25 that detects locking and unlocking, the number of times a user is detected by the pyroelectric sensor, the motion sensor, the temperature sensor, or the like, the number of sittings detected by the seat sensor of the toilet bowl device 30, and the number of drains detected by the drain sensor of the toilet bowl device 30.

The management device 50 determines toilet bowl devices 30 to be cleaned based on the number of uses of the toilet bowl devices 30 (S14). The management device 50 determines that toilet bowl devices 30 that have been used more than a predetermined number of uses are to be cleaned. The management device 50 may determine toilet bowl devices 30 to be cleaned based on clogging, odor, stain, etc. of the toilet bowl devices 30. The management device 50 may determine that a toilet bowl device 30 and a restroom 21 to be cleaned when it is detected that sewage has overflowed from the toilet bowl of the toilet bowl device 30 or when it is detected that a hand washing liquid set in the sink 26 has run out. The management device 50 may generate a cleaning instruction to the cleaning person in units of toilet bowl devices 30 and in units of restrooms 21 or may generate a cleaning instruction in units of cleaning details. If no toilet bowl device 30 is determined to be cleaned (N in S14), the step returns to S10.

If there are toilet bowl devices 30 determined to be cleaned (Y in S14), the management device 50 determines the cleaning order of the toilet bowl devices 30 determined to be cleaned (S16). In a directed graph whose starting point is the current position of the cleaning person and whose vertices respectively represent a plurality of toilet bowl devices 30 determined to be cleaned, the management device 50 determines the cleaning order of the plurality of toilet bowl devices 30 by solving for the optimal route that minimizes the total cost while using a value calculated from at least one or more of the following as the cost between the vertices:
the distance of travel or the travel time between the vertices; the existence of movements between floors, the number of movements between floors, or the means of movements between floors; the amount of time elapsed since the toilet bowl devices 30 have been determined to be cleaned; the degree of soiling of the toilet bowl devices 30; the number of uses of the toilet bowl devices 30; and the use status of the toilet bowl devices 30. The management device 50 may also convert each item into the time required and use the time required as the cost between the vertices. For example, if the cleaning person moves between floors when moving between the vertices, the travel time based on the number of movements between floors and the means of moving between the floors may be added to the travel time calculated from the distance of travel. In addition, if toilet bowl devices 30 to be cleaned are being in use, waiting time until the toilet bowl devices 30 are ready for cleaning may be added to the cost. Further, since it takes a lot of time to clean as the degree of soiling of the toilet bowl devices 30 increases, the cost may be increased. Since the toilet bowl devices 30 remain dirty for a long time as the amount of time elapsed after the toilet bowl devices 30 are determined to be cleaned increases, the cost may be reduced in order to raise the cleaning order. Further, as the degree of soiling and the number of uses of the toilet bowl devices 30 increase, the cost may be reduced in order to raise the cleaning order. As the travel time between vertices, an approximate value of travel time between regions to which the vertices belong may be used. For example, the approximate value of travel time may be assigned according to the hierarchical relationship between the vertices in hierarchical regions such as the facility 20, the floor 36, the area 35, and the restroom 21. The hierarchical relationship may be calculated in analogy to parentage, which is used as a measure of kinship closeness. The management device 50 may assign a weight to each item so as to calculate the cost of each item. The management device 50 may solve the optimal route problem using any algorithm, such as the Bellman-Ford method. The management device 50 may determine the cleaning order of the toilet bowl devices 30 based further on the occurrence of an emergency response for toilet clogging, etc., the poor flow of water in the pipes, the remaining amount of consumables such as toilet paper and soap, and the like. The management device 50 may include these factors in the cost so as to calculate the optimal route. The management device 50 may determine the cleaning order with the highest priority given to an emergency response when an event requiring an emergency response occurs.

The management device 50 notifies the cleaning person terminal 90 of the determined cleaning order of the toilet bowl devices (S18). The cleaning person terminal 90 presents the cleaning order of the toilet bowl devices as notified by the management device 50 to the cleaning person (S20).

When the cleaning person completes the cleaning of the toilet bowl devices 30 and inputs to the cleaning person terminal 90 information indicating that the cleaning has been completed, the cleaning person terminal 90 notifies the management device 50 of the completion of cleaning (S22). The management device 50 records the cleaning history of the toilet bowl devices 30 (S24). The management device 50 determines the cleaning order of the toilet bowl devices 30 determined to be cleaned (S16) and notifies the cleaning person terminal 90 of the latest cleaning order (S18). The cleaning person terminal 90 presents the cleaning order of the toilet bowl devices as notified by the management device 50 to the cleaning person (S20). The cleaning person moves to the installation location of the toilet bowl device to be cleaned next and cleans the toilet bowl device 30.

In a case where a plurality of toilet bowl devices installed in the facility 20 are to be cleaned by a plurality of cleaning persons, it may be predetermined such that toilet bowl devices to be cleaned by each cleaning person are not the same as those to be cleaned by another cleaning person.

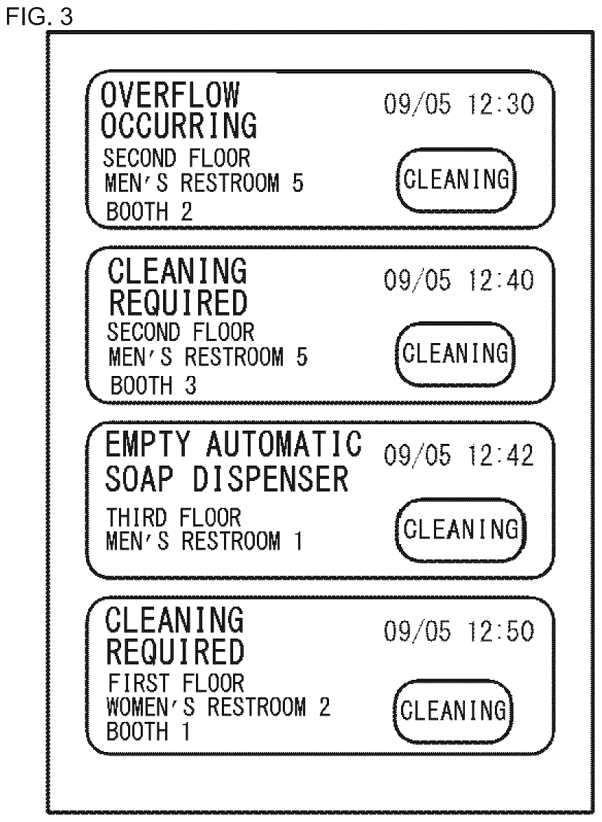

FIG. 3 shows an example of a display screen displayed by a cleaning person terminal 90. The cleaning person terminal 90 displays the toilet bowl devices 30 requiring cleaning as notified by the management device 50 on a display device according to the cleaning order as notified by the management device 50. As described above, each time the cleaning of a toilet bowl device 30 is completed, the latest cleaning order is determined, and the cleaning person terminal 90 is notified of the latest cleaning order. Thus, the cleaning person terminal 90 may display only the toilet bowl device 30 to be cleaned next on the display device. However, by also displaying the toilet bowl devices to be cleaned subsequently on the display device, it is possible to show the cleaning person the outlook for future cleaning.

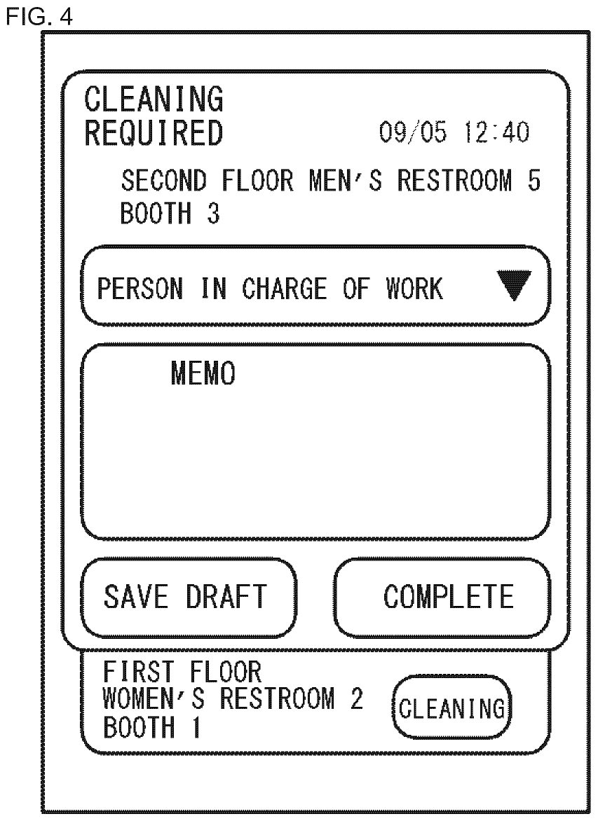

FIG. 4 shows an example of a display screen displayed by a cleaning person terminal 90. When the cleaning person completes the cleaning of a toilet bowl device 30, the cleaning person inputs information indicating the completion of the cleaning of the toilet bowl device 30 on the display screen shown on the display device of the cleaning person terminal 90. At this time, the details of the cleaning, the condition of the toilet bowl device 30 and the condition of the restroom 21, the existence and details of defects, and information about the cleaning person may be inputted. The results of the cleaning and the information input by the cleaning person may be checked and modified by the manager of the facility 20, the cleaning manager, other cleaning persons, and the like.

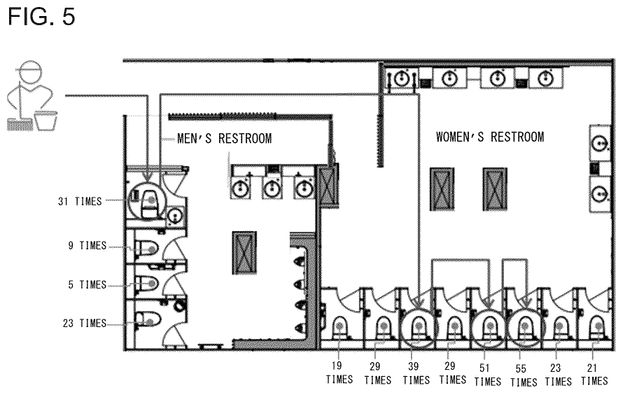

FIG. 5 shows an example of a display screen displayed by a cleaning person terminal 90. The cleaning person terminal 90 may display the toilet bowl devices 30 to be cleaned in a map format. In a map of a restroom 21, the number of uses of each toilet bowl device 30 and the cleaning order of the toilet bowl devices 30 to be cleaned are indicated.

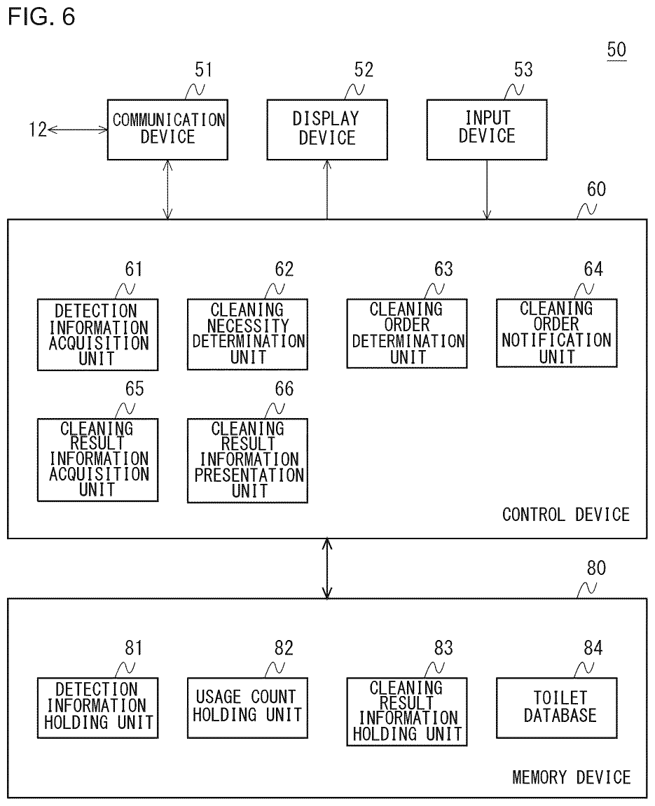

FIG. 6 shows the configuration of a management device 50 according to the embodiment. The management device 50 includes a communication device 51, a display device 52, an input device 53, a memory device 80, and a control device 60. The management device 50 may be a server device, a device such as a personal computer, or a portable terminal such as a cell phone terminal, a smart phone, a tablet terminal, or the like.

The communication device 51 controls communication between other devices. The communication device 51 may communicate by any wired or wireless communication method. The communication device 51 communicates with the communication device 22 via the Internet 12 and receives detection information detected by the sensor 33. The communication device 51 also communicates with the cleaning person terminal 90 via the Internet 12.

The display device 52 displays a screen generated by the control device 60. The display device 52 may be a liquid crystal display device, an organic EL display device, or the like. The input device 53 transmits instruction input from the user of the management device 50 to the control device 60. The input device 53 may be a mouse, a keyboard, a touchpad, or the like. The display device 52 and the input device 53 may be implemented as a touch panel.

The memory device 80 stores programs, data, and the like used by the control device 60. The memory device 80 may be a semiconductor memory, a hard disk, or the like. The memory device 80 stores a detection information holding unit 81, a usage count holding unit 82, a cleaning result information holding unit 83, and a toilet database 84.

The detection information holding unit 81 holds detection information detected by the sensor 33. The usage count holding unit 82 holds the number of uses of the toilet bowl devices 30 to be cleaned. The cleaning result information holding unit 83 holds information indicating the cleaning record of the toilet bowl devices 30 to be cleaned. The toilet database 84 holds information about the toilet bowl devices 30 to be cleaned. For example, the toilet database 84 retains information such as the installation location, the number of installations, the type, the amount of time elapsed since the installation, the frequency of use, and the frequency of cleaning of the toilet bowl devices 30.

The control device 60 includes a detection information acquisition unit 61, a cleaning necessity determination unit 62, a cleaning order determination unit 63, a cleaning instruction notification unit 64, a cleaning result information acquisition unit 65, and a cleaning result information presentation unit 66. The configuration is implemented in hardware by any CPU of a computer, memory, other LSI's, or the like and in software by a program or the like loaded into the memory. Here, functional blocks implemented by the cooperation of hardware and software are depicted. Thus, a person skilled in the art should appreciate that there are many ways of accomplishing these functional blocks in various forms in accordance with the components of hardware only or the combination of hardware and software.

The detection information acquisition unit 61 acquires detection information detected by the sensor 33 from the communication device 22 and stores the detection information in the detection information holding unit 81.

The cleaning necessity determination unit 62 calculates the number of uses of the toilet bowl devices 30 based on the detection information and updates the number of uses of the toilet bowl devices 30 stored in the usage count holding unit 82. The cleaning necessity determination unit 62 determines toilet bowl devices 30 to be cleaned based on the number of uses of the toilet bowl devices 30 stored in the usage count holding unit 82.

The cleaning order determination unit 63 determines the cleaning order of the toilet bowl devices 30 that are determined to be cleaned by the cleaning necessity determination unit 62. The cleaning order determination unit 63 determines the cleaning order of the plurality of toilet bowl devices 30 by solving for the optimal route in a directed graph whose starting point is the current position of the cleaning person and whose vertices respectively represent the plurality of toilet bowl devices 30 determined to be cleaned. As the current position of the cleaning person, the cleaning order determination unit 63 may acquire information indicating the current position from the cleaning person terminal 90 or may read the location of a toilet bowl device most recently cleaned by the cleaning person from the cleaning result information holding unit 83. The cleaning person terminal 90 may acquire information indicating the current position using GPS, beacons, etc.

The cleaning instruction notification unit 64 notifies the cleaning person terminal 90 of information on the toilet bowl devices 30 determined to be cleaned by the cleaning necessity determination unit 62 and a cleaning instruction including the cleaning order determined by the cleaning order determination unit 63.

The cleaning result information acquisition unit 65 acquires the cleaning result information from the cleaning person terminal 90 and stores the cleaning result information in the cleaning result information holding unit 83.

The cleaning result information presentation unit 66 reads the cleaning result information held in the cleaning result information holding unit 83 and presents the cleaning result information to the manager of the facility 20, the cleaning manager, other cleaning persons, and the like.

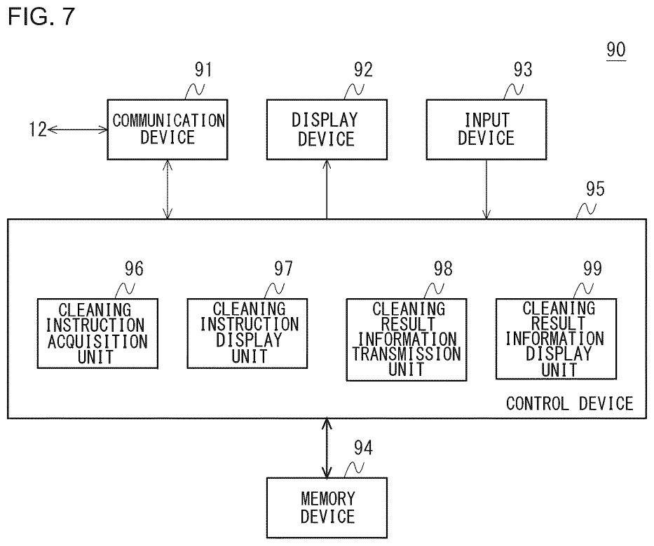

FIG. 7 shows the configuration of the cleaning person terminal 90 according to the embodiment. The cleaning person terminal 90 includes a communication device 91, a display device 92, an input device 93, a memory device 94, and a control device 95. The cleaning person terminal 90 may be a server device, a device such as a personal computer, or a portable terminal such as a cell phone terminal, a smart phone, a tablet terminal, or the like.

The communication device 91 controls communication with other devices. The communication device 91 may communicate by any wired or wireless communication method. The communication device 51 communicates with the management device 50 via the Internet 12.

The display device 92 displays a screen generated by the control device 95. The display device 92 may be a liquid crystal display device, an organic EL display device, or the like. The input device 93 communicates instruction input from the cleaning person to the control device 95. The input device 93 may be a mouse, a keyboard, a touchpad, or the like. The display device 92 and the input device 93 may be implemented as a touch panel. The memory device 94 stores programs, data, and the like used by the control device 95.

The control device 95 includes a cleaning instruction acquisition unit 96, a cleaning instruction display unit 97, a cleaning result information transmission unit 98, and a cleaning result information display unit 99. These configurations can be accomplished in various forms in accordance with the components of hardware only or the combination of hardware and software.

The cleaning instruction acquisition unit 96 acquires a cleaning instruction from the management device 50. The cleaning instruction display unit 97 displays the cleaning instruction acquired by the cleaning instruction acquisition unit 96 on the display device 92. The cleaning instruction display unit 97 displays on the display device 92 the toilet bowl devices to be cleaned according to the cleaning order included in the cleaning instruction.

When the cleaning person completes cleaning a toilet bowl device 30, the cleaning result information transmission unit 98 transmits to the management device 50 information indicating the completion of the cleaning and cleaning result information indicating the details of the cleaning and the like. The cleaning result information display unit 99 acquires cleaning result information input by other cleaning persons from the management device 50 and displays the cleaning result information on the display device 92.

While the present disclosure has been described based on the embodiment, the embodiment is merely illustrative of the principles and applications of the present disclosure. Additionally, many variations and changes in arrangement may be made in the embodiment without departing from the spirit of the present disclosure as defined by the appended claims.

In the embodiment, an example of managing toilet bowl devices installed in a restroom of an institution is explained. However, the technology of the present embodiment is also applicable to managing toilets in general residences or public toilets installed in parks or on streets. The technology according to the present embodiment is also applicable to managing facilities and equipment such as faucets and automatic soap dispensers installed in restrooms. Further, the management system 10 according to the present disclosure is also capable of managing urinals in the same manner as toilet bowl devices.

What is claimed is:

1. A management system comprising:
a management device that manages cleaning of a plurality of toilet bowl devices,
the management device including a controller configured to:
acquire information acquired by sensors installed in the plurality of toilet bowl devices or at the installation locations of the plurality of toilet bowl devices;
determine toilet bowl devices to be cleaned based on the information acquired by the controller;
determine the cleaning order of the plurality of toilet bowl devices that are determined to be cleaned by the controller; and
notify the terminal device of the cleaning order determined by the controller, and
a terminal device that is used by a cleaning person for the toilet bowl devices, the terminal device including
a display that presents the cleaning order of the toilet bowl devices as notified by the management device to the cleaning person.

2. The management system of claim 1,
wherein the controller is configured to determine that toilet bowl devices that have been used more than a predetermined number of uses are to be cleaned.

3. The management system of claim 1,
wherein the controller is configured to determine the cleaning order of the plurality of toilet bowl devices based on at least one of the following: a distance of travel, a travel time, an existence of movements between floors, a number of movements between floors, or a means of movements between floors, at the time of moving to the toilet bowl devices to be cleaned; an amount of time elapsed since the toilet bowl devices have been determined to be cleaned; a degree of soiling of the toilet bowl devices; a number of uses of the toilet bowl devices; and a use status of the toilet bowl devices.

4. The management system of claim 3,
wherein in a directed graph whose starting point is the current position of the cleaning person and whose vertices respectively represent the plurality of toilet bowl devices determined to be cleaned by the controller, the controller is configured to determine the cleaning order of the plurality of toilet bowl devices by solving for the optimal route that minimizes a cost calculated from at least one or more of the following: the distance of travel or the travel time between the vertices, the existence of movements between floors, the number of movements between floors, or the means of movements between floors, the amount of time elapsed since the toilet bowl devices have been determined to be cleaned; the degree of soiling of the toilet bowl devices; the number of uses of the toilet bowl devices; and the use status of the toilet bowl devices.

5. A management device comprising:
a controller configured to:
acquire information acquired by sensors installed in a plurality of toilet bowl devices or at the installation locations of the plurality of toilet bowl devices;
determine toilet bowl devices to be cleaned based on the information acquired by the controller;
determine the cleaning order of the plurality of toilet bowl devices that are determined to be cleaned by the controller; and
notify a terminal device used by a cleaning person for the toilet bowl devices of the controller.

6. A non-transitory computer readable medium storing a management program causing a computer to implement:
acquiring information acquired by sensors installed in a plurality of toilet bowl devices or at the installation locations of the plurality of toilet bowl devices;
determining toilet bowl devices to be cleaned based on the information acquired;
determining a cleaning order of the plurality of toilet bowl devices that are determined to be cleaned; and
notifying a terminal device used by a cleaning person for the toilet bowl devices of the cleaning order determined.

7. A terminal device comprising:
a display that presents to a cleaning person a cleaning order of toilet bowl devices notified by a management device configured to determine the toilet bowl devices to be cleaned based on information acquired by sensors installed in a plurality of the toilet bowl devices or at the installation locations of the plurality of the toilet bowl devices and to determine the cleaning order of the toilet bowl devices determined to be cleaned.

8. A non-transitory computer readable medium storing a management program causing a computer to implement:
presenting to a cleaning person a cleaning order of toilet bowl devices notified by a management device configured to determine the toilet bowl devices to be cleaned based on information acquired by sensors installed in a plurality of the toilet bowl devices or at the installation locations of the plurality of the toilet bowl devices and to determine the cleaning order of the toilet bowl devices determined to be cleaned.

9. The management system of claim 2,
wherein the controller is configured to determine the cleaning order of the plurality of toilet bowl devices based on at least one of the following: a distance of travel, a travel time, an existence of movements between floors, a number of movements between floors, or a means of movements between floors, at the time of moving to the toilet bowl devices to be cleaned; an amount of time elapsed since the toilet bowl devices have been determined to be cleaned; a degree of soiling of the toilet bowl devices; a number of uses of the toilet bowl devices; and a use status of the toilet bowl devices.

10. The management system of claim 9,
wherein in a directed graph whose starting point is the current position of the cleaning person and whose vertices respectively represent the plurality of toilet bowl devices determined to be cleaned by the controller, the controller is configured to determine the cleaning order of the plurality of toilet bowl devices by solving for the optimal route that minimizes a cost calculated from at least one or more of the following: the distance of travel or the travel time between the vertices, the existence of movements between floors, the number of movements between floors, or the means of movements between floors, the amount of time elapsed since the toilet bowl devices have been determined to be cleaned; the degree of soiling of the toilet bowl devices; the number of uses of the toilet bowl devices; and the use status of the toilet bowl devices.

11. The management device of claim 5,
wherein the controller is configured to determine that toilet bowl devices that have been used more than a predetermined number of uses are to be cleaned.

12. The management device of claim 5,
wherein the controller is configured to determine the cleaning order of the plurality of toilet bowl devices based on at least one of the following: a distance of travel, a travel time, an existence of movements between floors, a number of movements between floors, or a means of movements between floors, at the time of moving to the toilet bowl devices to be cleaned; an amount of time elapsed since the toilet bowl devices have been determined to be cleaned; a degree of soiling of the toilet bowl devices; a number of uses of the toilet bowl devices; and a use status of the toilet bowl devices.

13. The management device of claim 11,
wherein the controller is configured to determine the cleaning order of the plurality of toilet bowl devices based on at least one of the following: a distance of travel, a travel time, an existence of movements between floors, a number of movements between floors, or a means of movements between floors, at the time of moving to the toilet bowl devices to be cleaned; an amount of time elapsed since the toilet bowl devices have been determined to be cleaned; a degree of soiling of the toilet bowl devices; a number of uses of the toilet bowl devices; and a use status of the toilet bowl devices.

14. The management device of claim 12,
wherein in a directed graph whose starting point is the current position of the cleaning person and whose vertices respectively represent the plurality of toilet bowl devices determined to be cleaned by the controller, the controller is configured to determine the cleaning order of the plurality of toilet bowl devices by solving for the optimal route that minimizes a cost calculated from at least one or more of the following: the distance of travel or the travel time between the vertices, the existence of movements between floors, the number of movements between floors, or the means of movements between floors, the amount of time elapsed since the toilet bowl devices have been determined to be cleaned; the degree of soiling of the toilet bowl devices; the number of uses of the toilet bowl devices; and the use status of the toilet bowl devices.

15. The management device of claim 13,
wherein in a directed graph whose starting point is the current position of the cleaning person and whose vertices respectively represent the plurality of toilet bowl devices determined to be cleaned by the controller, the controller is configured to determine the cleaning order of the plurality of toilet bowl devices by solving for the optimal route that minimizes a cost calculated from at least one or more of the following: the distance of travel or the travel time between the vertices, the existence of movements between floors, the number of movements between floors, or the means of movements between floors, the amount of time elapsed since the toilet bowl devices have been determined to be cleaned; the degree of soiling of the toilet bowl devices; the number of uses of the toilet bowl devices; and the use status of the toilet bowl devices.
